(19) United States
(12) Patent Application Publication
(10) Pub. No.: US 2011/0077970 A1
(43) Pub. Date: Mar. 31, 2011

(54) METHOD, APPARATUS AND COMPUTER PROGRAM PRODUCT FOR PROVIDING A PATIENT QUALITY MONITOR

(76) Inventors: Andrew Mellin, St. Paul, MN (US); Keith Willard, St. Paul, MN (US); Catherine Whelchel, Spartanburg, SC (US); Josef Pusedu, Boulder, CO (US)

(21) Appl. No.: 12/570,758

(22) Filed: Sep. 30, 2009

(51) Int. Cl. G06Q 50/00; G06Q 10/00; G06F 3/048

(52) U.S. Cl. 705/3; 705/11; 715/772

(57) ABSTRACT

A method for providing a patient quality monitor may include receiving an identification of quality metrics associated with each of a plurality of health care conditions in which the quality metrics correspond to external standards of care for the respective health care conditions, extracting clinical patient quality data regarding activities corresponding to the quality metrics identified from a database, sorting the clinical patient quality data according to health care condition, and presenting compliance data on a dashboard display indicative of compliance with the quality metrics of a selected one of the health care conditions based on the sorted clinical patient quality data. A corresponding computer program product and apparatus are also provided.

### TECHNOLOGICAL FIELD

Embodiments of the present invention relate generally to health care management solutions and, more particularly, relate to an appliance and pair device for providing a patient quality monitor.

### BACKGROUND

For many years, the mechanism for evaluating clinical processes related to a particular patient has been the medical chart or medical record. As such, for example, the medical record has been used to record patient identification, health history, medical examination and/or lab test results, medical prescriptions and other information such as, for example, orders related to the particular treatments or diagnoses associated with the patient. Accordingly, in order to assess whether a patient has received or is due to receive a particular treatment or care related event, the patient's chart would typically be reviewed.

For many illnesses, conditions or treatments, there may be standard activities that are performed, in some cases at periodic intervals, to improve patient outcomes. For example, ventilator associated pneumonia (VAP) is a condition that is not uncommon for patients who are placed on a ventilator and can be either fatal or greatly increase health care costs and patient stays. In order to reduce the incidence of VAP various standard quality metrics have been defined for clinicians to perform at periodic intervals. Compliance with the quality standards can decrease the likelihood of the incidence of VAP for a patient on a ventilator. As indicated above, the mechanism for monitoring compliance with the quality standards would typically be accomplished via chart review. However, this does not provide a very easy way for clinicians to track compliance.

Recently, efforts have been made to move to electronic medical records (EMR). Although the EMR concept has encountered many issues in relation to, for example, cost, security, interoperability, many hospitals are either employing, or planning to employ, some form of EMR. With clinical documentation systems moving to electronic media, clinical data may be available for incorporation into applications to assist in the management or use of such data. Computerized provider order entry (CPOE) is one example of a development that may improve the ability to electronically access information related to physician's orders. Thus, the availability of electronic clinical data is increasing.

Accordingly, it may be desirable to provide a mechanism by which compliance with individual quality metrics for various quality standards may be tracked, in some cases, using already existing electronic clinical data.

### BRIEF SUMMARY

A method, apparatus and system are therefore provided to enable the provision of a patient quality monitor that may address some of the problems discussed above. Accordingly, for example, a dashboard may be presented to give clinicians an “at a glance” view of tasks that are to be completed to provide compliance with regulatory and/or local treatment standards.

In one exemplary embodiment, a method for providing a patient quality monitor is provided. The method may include receiving an identification of quality metrics associated with each of a plurality of health care conditions in which the quality metrics correspond to external standards of care for the respective health care conditions, extracting clinical data regarding activities corresponding to the quality metrics identified from a database, sorting the clinical quality data according to health care condition, and presenting compliance data on a dashboard display indicative of compliance with the quality metrics of a selected bundle of the health care conditions based on the sorted clinical quality data.

In another exemplary embodiment, a computer program product for providing a patient quality monitor is provided. The computer program product may include at least one computer-readable storage medium having computer-executable program code instructions stored therein. The computer-executable program code instructions may include program code instructions for receiving an identification of quality metrics associated with each of a plurality of health care conditions in which the quality metrics correspond to external standards of care for the respective health care conditions, extracting clinical data regarding activities corresponding to the quality metrics identified from a database, sorting the clinical data according to health care condition, and presenting compliance data on a dashboard display indicative of compliance with the quality metrics of a selected one of the health care conditions based on the sorted clinical quality data.

In another exemplary embodiment, an apparatus for providing a patient quality monitor is provided. The apparatus may include processing circuitry. The processing circuitry may be configured for receiving an identification of quality metrics associated with each of a plurality of health care conditions in which the quality metrics correspond to external standards of care for the respective health care conditions, extracting clinical data regarding activities corresponding to the quality metrics identified from a database, sorting the clinical data according to health care condition, and presenting compliance data on a dashboard display indicative of compliance with the quality metrics of a selected one of the health care conditions based on the sorted clinical process data.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing a reliable quality monitor according to an exemplary embodiment of the present invention;

FIG. 2 is a block diagram showing various components that may be included in an apparatus for providing a patient quality monitor according to an exemplary embodiment of the present invention;

FIG. 3 shows an example display of a patient quality monitor according to an exemplary embodiment of the present invention;

FIG. 4 shows another example of a display of a patient quality monitor according to an exemplary embodiment of the present invention;

FIG. 5 shows yet another example of a display of a patient quality monitor according to an exemplary embodiment of the present invention;

FIG. 6 illustrates an example display of an alternative view of patient quality data that may be provided according to an exemplary embodiment of the present invention;

FIG. 7 illustrates an example display of yet another alternative view of patient quality data that may be provided according to an exemplary embodiment of the present invention;

FIG. 8 shows an example display of a detailed patient window according to an exemplary embodiment of the present invention;

FIG. 9 shows another example of a display of a patient quality monitor according to an exemplary embodiment of the present invention; and

FIG. 10 is a block diagram according to an exemplary method for providing a patient quality monitor according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which compliance with regulatory and/or local treatment standards may be monitored. In some embodiments, a patient quality monitor is provided to help clinicians absorb large quantities of information, or at least key bits of information, in a relatively short time. In this regard, dashboards often provide a graphical representation of key performance indicators or other information in a relatively easy to read manner. Thus, embodiments of the present invention may provide a relatively easy way by which clinicians may obtain an “at a glance” view of tasks that are to be performed to ensure regulatory standards are met. However, some dashboards may be limited to the specific purposes for which they have been constructed and thus may not provide flexibility with respect to implementing local standards that may be developed at a particular hospital. Some embodiments of the present invention may also provide flexibility for including local standards and tailoring the presentation of information to the desires of the user and the benefits of the patient.

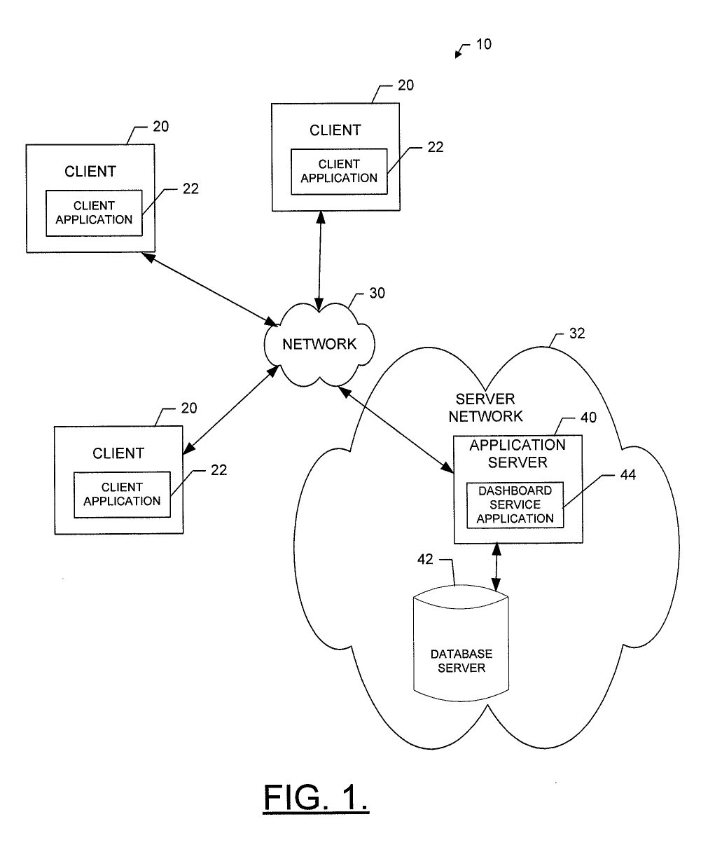

An exemplary embodiment of the invention will now be described in reference to FIG. 1, which illustrates an exemplary system in which an embodiment of the present invention may be employed. As shown in FIG. 1, a system according to an exemplary embodiment may include one or more clients 20 that may, in some cases, be associated with different corresponding units, wings or departments of a hospital or healthcare system. For example, one client 20 may be associated with a first hospital unit (e.g., an intensive care unit (ICU)) and a second client 20 may be associated with a second hospital unit (e.g., a respiratory therapy unit). However, information associated with multiple units may alternatively be accessible via a single client. Furthermore, in some cases, multiple clients may be associated with the same unit. For example, clients 20 could be located at nurse's stations, at various locations in hallways within a treatment unit or even within patient rooms.

Each client 20 may be, for example, a computer (e.g., a personal computer, laptop computer, network access terminal, or the like) or may be another form of computing device (e.g., a personal digital assistant (PDA), cellular phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an exemplary embodiment, one or more of the clients 20 may include a client application 22 configured to operate in accordance with an exemplary embodiment of the present invention. In this regard, for example, the client application 22 may include software for enabling a respective one of the clients 20 to communicate with the network 30 for the provision of and receipt of information associated with providing a patient quality monitor. As such, for example, the client application 22 may include corresponding executable instructions for configuring the client 20 to provide corresponding functionalities for the provision of and receipt of information associated with providing the patient quality monitor as described in greater detail below. Moreover, in an exemplary embodiment, the client application 22 may include functionality for providing modification to the format and/or content of the patient quality monitor.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an exemplary embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers”, this does not necessarily imply that they are embodied on separate servers or devices. As such, for example, a single server or device may include both entities and the database server 42 could merely be represented by a database or group of databases physically located on the same server as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an exemplary embodiment, one function that may be provided by the application server 40 may be the provision of a patient quality monitor to the clients 20. In this regard, for example, the application server 40 may include a dashboard service application 44 comprising stored instructions for accessing information and providing such information to the client applications 22 based on requests provided at each respective client 20.

Additionally or alternatively, the application server 40 may be configured to enable the clients 20 to provide information to the application server 40, for use by the application server 40 in producing, maintaining and/or supplying the patient quality monitor. In this regard, for example, the application server 40 (or servers) may include particular applications related to various different electronic medical record modules (e.g., CPOE or others). As such, some application servers may host data entry mechanisms that enable the entry of patient information, treatment information, test results, medical history, orders, medications, and numerous other types of information for storage in the database server 42. In other words, the database server 42 may form a fact repository to accept core clinical data updates of observations, medication administrations, intravenous (IV) administrations, orders and other similar data that may be provided in the context of an EMR or other hospital or healthcare system electronic data gathering and/or storage regimes.

In one embodiment, the fact repository may enhance patient data through associations with clinical concepts to form structured data. As a result of the associations with clinical concepts, the fact repository, which may in some cases include a processor and memory for enabling processing and storage, may process the patient data in various manners, such as by transforming the patient data to a standard representation. For example, in instances in which the data represents the patient's temperature, the fact repository may be configured to transform the temperature from a simple string representation, such as 101.9F, to a strongly-typed internal, floating-point representation of the value. Through associations with clinical terms and rules related to the clinical terms, the fact repository may also determine one or more attributes associated with the transformed value. For example, the fact repository may, in the foregoing example, compare the transformed temperature value to a normal range of temperature values and determine if the patient's temperature is high, normal or low. These attributes may then be stored along with or otherwise in association with the patient data.

The fact repository and the clinical process driver may then process the structured data in accordance with rules associated with clinical concepts in order to further characterize and specify the nature of the patient data. For example, the fact repository, in conjunction with the clinical process driver, may be configured to determine trends with respect to the patient data. The definition of a trend may be dependent upon the type of patient data. For example, with respect to body temperature, three consecutive body temperature recordings above the normal range within the preceding 12 hours may define a trend that creates an additional clinical fact that may be stored in addition to the underlying patient data.

As indicated above, the fact repository may also include memory for storing the patient data, attributes related to the patient data and clinical facts that are created by analysis of the patient data. While the patient data may be stored within the memory of the fact repository while and at least shortly after the patient data is processed by the processor of the fact repository, other storage devices may also be provided, such as random access memory.

In an exemplary embodiment, the application server 40 may include or have access to memory (e.g., internal memory or the database server 42) for storing instructions or applications for the performance of various functions and a corresponding processor for executing stored instructions or applications. In an exemplary embodiment, the application server 40 may include the dashboard service application 44 configured to operate in accordance with an exemplary embodiment of the present invention. In this regard, for example, the dashboard service application 44 may include software for enabling the application server 40 to communicate with the network 30 and/or the clients 20 for the provision and/or receipt of information associated with providing the patient quality monitor. As such, for example, the client application 22 may include corresponding executable instructions for configuring the client 20 to request information (e.g., from the dashboard service application 44) regarding one or more patients to enable the presentation of the patient quality monitor at the client 20. The dashboard service application 44 may therefore be configured to provide corresponding functionalities for the provision and/or receipt of information associated with providing the patient quality monitor as described in greater detail below. However, in an exemplary embodiment, the client application 22 may itself include all the functionality for accessing information for use in the patient quality monitor and for generating the patient quality monitor as described herein, without necessity for interface with an application server 40 or the dashboard service application 44. As such, rather than operating in a client/server relationship as described herein, some embodiments of the present invention may involve processing that is entirely accomplished in the device presenting the dashboard.

As indicated above, the database server 42 may act as a fact repository for electronically recorded clinical data regarding various activities performed with respect to a particular patient. In an exemplary embodiment, the clinical data that is written to the database server 42 may be mapped to a core-clinical ontology providing a framework for classifying the data. For example, a life-sciences ontology may be employed to provide a target representation of data for use in a patient quality monitor application. The core-clinical data may be transformed to a structured, strongly-typed form and represented as instances within the life-sciences model. Once transformed, the instances may be rationalized based on attributes such as normal, abnormal, outside normal range, within normal range, or other applicable attributes. Transformed and rationalized data may then be stored in the database server 42. In an exemplary embodiment, the database server 42 may comprise a long-term, persistent triple data store (TDS) that may be available for sending data to other applications as strongly-typed items. Alternatively or additionally, the data stored in the database server 42 may be available for querying or searching and reporting or driving applications such as, for example, a patient quality monitor application as either the dashboard service application 44 or the client application 22. Once posted to the TDS, data can trigger or otherwise be used in connection with rule processing, including potentially complex rule processing, based on trigger mappings within the life-sciences model. As such, for example, a particular condition may be monitored by setting up rules that extract specific data from the database server 42 for use in the clinical dashboard application to provide a patient quality monitor. In this regard, as a specific example, clinical data associated with VAP or some other condition such as CHF (congestive heart failure), sepsis, CVA (stroke), or others that may have associated externally generated quality metrics for early or preventive care.

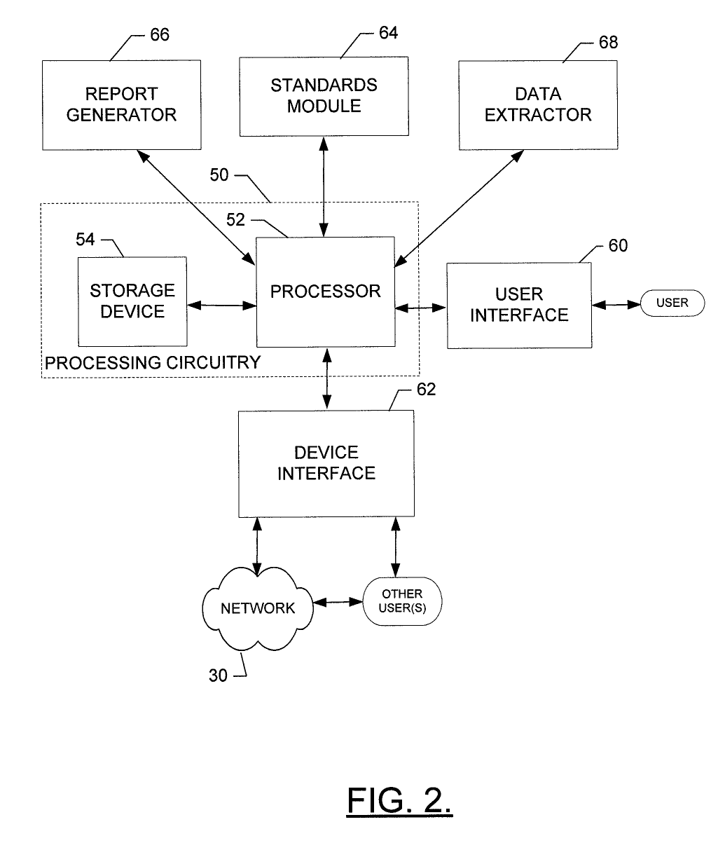

An exemplary embodiment of the invention will now be described with reference to FIG. 2. FIG. 2 shows certain elements of an apparatus for providing a patient quality monitor according to an exemplary embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for providing a patient quality monitor is provided. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 22) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 54 may include one or more memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or dashboard service application 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control a standards module 64, a report generator 66 and a data extractor 68. The standards module 64, the report generator 66 and the data extractor 68 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the standards module 64, the report generator 66 and the data extractor 68, respectively, as described below.

The standards module 64 may be configured to provide quality metrics for various different bundles. In this regard, for example, VAP monitoring may be one bundle for which the apparatus may provide quality monitoring and thus, VAP standards may form one set of standards provided by the standards module 64. Other diseases, chronic conditions or diagnoses may also have respective quality standards associated therewith and thus, may each form respective bundles serviced by the apparatus and having their own respective standards for preventive care provided by the standards module 64. In an exemplary embodiment, the standards module 64 may access (or have stored therein) external standards associated with strategies to reduce the incidence of complications associated with various conditions or treatments. The standards may therefore define individual quality metrics related to activities that, if carried out at a prescribed time or interval, may reduce the likelihood of encountering complications or other negative outcomes. The quality metrics of external standards may be defined by external organizations such as, for example, the Institute for Healthcare Improvement (IHI), Centers for Disease Control (CDC), Joint Commission on the Accreditation of Healthcare Organizations (JCAHO), Agency for Healthcare Research and Quality (AHRQ) or other similar agencies or bodies.

As an example, VAP quality metrics may include elevating the head of the bed 30 to 45 degrees at least two times in a 24 hour period with eight hours between observations, a daily interruption of sedation (“sedation vacation”) until the patient is able to follow commands, a daily assessment of readiness to extubate, checking the VAP order set, peptic ulcer disease (PUD) prophylaxis also known as stress ulcer disease (SUD) prophylaxis, oral care, and deep venous thrombosis (DVT) prophylaxis also known as venous Thromboembolism (VTE) prophylaxis. Thus, for example, each quality metric may form a corresponding basis for monitoring that may be communicated to the data extractor 68. The data extractor 68 may then extract corresponding data from the fact repository (e.g., the database server 42) to provide indications with regard to status for a particular patient in relation to the quality metrics.

In some cases, the standards module 64 may be configured to enable end users of the patient monitor (or information and technology personnel of the hospital or healthcare systems) to define local standards to supplement the external standards. Thus, for example, if a particular hospital desires to add additional preventive care measures to be monitored, the standards module 64 may enable modification of the quality metrics to include local standard related activities to be communicated to the data extractor 68 for monitoring and inclusion in the patient quality monitor display when appropriate.

The data extractor 68 may be configured, as indicated above, to extract data regarding activities logged or otherwise recorded that correspond to quality metrics. Thus, for example, results of observations or orders that have been conducted and recorded electronically in the database server 42 may be extracted on a routine, periodic or continuous basis in order to provide updated information regarding status with respect to each quality metric. For example, the data extractor 68 may be configured to update the status of each quality metric every five minutes or at some other regular interval. However, in some cases, the data extractor 68 may be configured to update the status of selected quality metrics such as, for example, the quality metrics for a condition currently selected for display in response to the selection of the selection of the corresponding condition. In such an example, updates thereafter may only be accomplished for quality metrics associated with the displayed condition and not necessarily for all quality metrics to reduce processor loading. Accordingly, in an exemplary embodiment, the data extractor 68 may be configured to receive an identification of quality metrics associated with each of a plurality of health care conditions in which the quality metrics correspond to external standards (and in some cases also local standards) of care for the respective health care conditions. The data extractor 68 may further be configured to extract clinical process data regarding activities corresponding to the quality metrics identified from a database (e.g., the database server 42).

The report generator 66 may be configured to generate a user interface display comprising a patient quality monitor based on the information provided by the data extractor 68 and rules for displaying such information as defined for each respective condition for which compliance monitoring is provided by the dashboard service application 44. In other words, the report generator 66 provides a display of selected data on the patient quality monitor in a selected manner. As an example, the report generator 66 may be configured to display status indicators for each of a plurality of quality metrics associated with one of a plurality of conditions selectable by the user. As such, in an exemplary embodiment, the report generator 66 may be configured to sort the clinical process data provided by the data extractor 68 according to health care condition and present compliance data on a dashboard display indicative of compliance with the quality metrics of a selected one of the health care conditions based on the sorted clinical process data. As such, patient quality monitoring may be accomplished for each patient for which clinical process data is extracted. In this regard, the monitoring may be automatic in that there may be no requirement for user interaction to enroll patients for monitoring. Instead, the appearance of data on a display for quality monitoring is driven by the data or documentation received for each patient and not based on user activity with respect to requesting such information.

In providing the presentation of compliance data on the dashboard display, the report generator 66 may be configured to provide the user with enablement for tailoring the display and/or the dashboard itself to the user's desires in many ways. For example, in addition to selecting a single condition that is to form the basis for a particular dashboard display based on a predetermined format, the user may author particular enhancements or modifications to tailor the dashboard to the user's needs or desires. As an example, the user may select a color scheme or coding scheme for indicating different status conditions. Ordering of the bundles (e.g., conditions) and/or of the quality metrics within the bundles with respect to selectable tabs for displaying condition related compliance data may also be user selectable. Furthermore, in some cases, the user may select during use or author prior to use to make certain quality metrics a compilation of other metrics within a particular bundle. For example, a quality metric associated with a particular condition may include multiple reported activities. Some users may desire to have the quality metric combined into a single status indicator, while other users may desire to have each of the multiple activities separately reported with their own respective status indicators. The report generator 66 may provide flexible user control over the presentation to accommodate either desire.

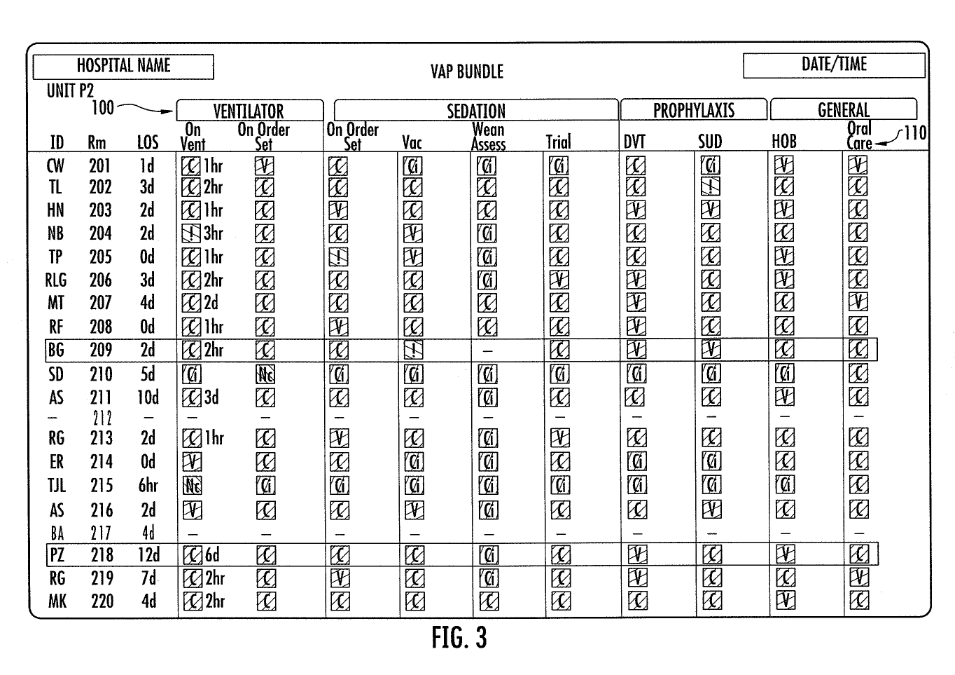

In an exemplary embodiment, the presentation of compliance data in the dashboard display may be provided via a plurality of different bases, which may be user selectable. As an example, compliance data may be presented on a per unit basis, a per condition basis, a per patient basis, a per clinician basis, combinations of the above, or based on other criteria. FIGS. 3-5 display some example dashboards to illustrate some of these options. In this regard, FIG. 3 shows a VAP bundle dashboard display for a single unit, wing or floor (e.g., 2XX series rooms). The far left columns in the display of FIG. 3 provide a patient identity (ID) (e.g., via patient initials), the patient's room number (Rm) and the length of the patient's stay (LOS). Remaining columns for this bundle provide quality metric topics 100 (e.g., ventilator, sedation, prophylaxis and general) and individual quality metrics 110 (e.g., On Vent, On Order Set, Vac, Wean Assess, DVT, SUD, HOB, Oral Care). Color coded and/or text coded status indicators are then provided for each patient beneath the corresponding quality metrics. The status codings may be defined, for example, in a state table that is referenced by the report generator 66 for use in generating a display.

Some example codings are provided below, but it should be appreciated that the examples below are non-limiting. In this regard, a green color indicator and/or the letter “C” (or “Co”) may indicate a state name of “compliant” that corresponds to a state description of “metric completed on time”. A “compliant” indication may be provided when the corresponding activity has been charted as being complete. A blue color indicator and/or the letter “Nc” may indicate a state name of “non-compliant” that corresponds to a state description of “metric not completed before a corresponding time limit expired”. A “non-compliant” indication may be provided when the corresponding metric measurement time period has expired without charting the corresponding activity as being complete. A yellow color indicator and/or the letters “ACT” may indicate a state name of “actionable” that corresponds to a state description of “metric is applicable to patient and ready for completion”. An “actionable” indication may be provided for a corresponding quality metric from the time of applicability until a predetermined time period before the compliance time period is set to expire (e.g., 1 hour) or until the metric becomes compliant. A red color indicator and/or the exclamation point!” may indicate a state name of “urgent” (or “critical”) that corresponds to a state description of “metric requires urgent attention for completion prior to the rapidly approaching expiration of the time limit for completion”. A “critical” or “urgent” indication may be provided from a predetermined time before the compliance time period is set to expire (e.g., 1 hour) until the metric becomes compliant or until the metric becomes non-compliant. A gray color indicator and/or the letter “Ci” may indicate a state name of “contraindicated” that corresponds to a state description of “metric is excluded for this patient based on some documented contraindication”. A “contraindicated” indication may be provided when the corresponding quality metric has been charted as being contraindicated. A dash of any color or letters “N/A” may indicate a state name of “Not applicable” that corresponds to a state description of “entire bundle is excluded for this patient”. A “Not applicable” indication may be provided when charting is completed to indicate contraindication or exclusion from the bundle. Other coding schemes could also be employed and/or the coding scheme described above may be modified. However, in most cases, clinicians may review the dashboard and relatively quickly determine which activities need to be performed soon (e.g., red or urgent quality metrics) for each patient in the unit and which activities will be coming due thereafter. Thus, the dashboard of FIG. 3 may be useful at a nurse's station or other central location within a unit to assist clinicians with management of time and personnel resources in order to achieve compliance with established standards indicated by the quality metrics displayed. Notably, although the patient information displayed in FIG. 3 is shown in order by room number, other orderings could be provided. For example, the patient information could be displayed based on urgency such that patients with higher numbers of urgent items are placed near the top and patients with fewer numbers of urgent items are placed near the bottom.

In some embodiments, quality monitor updating may occur based on charting and/or clinician documentation that occurs after non-compliance as well. Thus, for example, if a particular quality metric goes into non-compliance, the display may still be updated to reflect the current status. In some cases, such as when the non-compliant status was due to a charting error or failure to record activity that actually occurred on-time, the prior indication of non-compliance may be removed in response to receipt of an indication of the occurrence of the correct action and the display may be updated accordingly. In examples in which the next action is already in play in terms of being monitored and reported, the display may be updated to reflect the status of the next action.

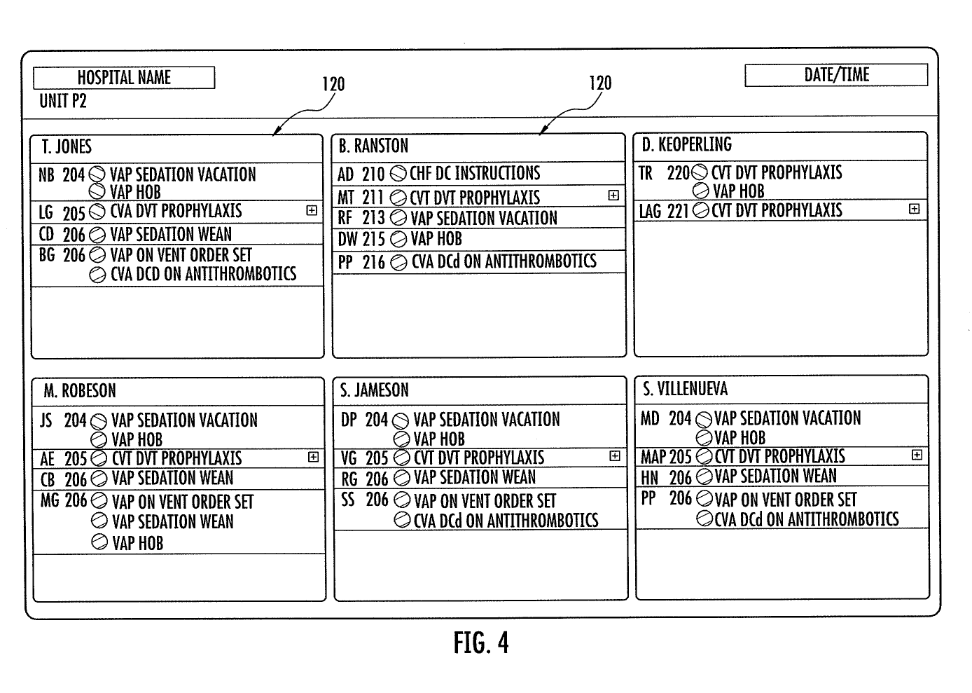

FIG. 4 illustrates a dashboard display organized on a per clinician basis. In this regard, for example, a clinician (e.g., nurse) identifier such as the clinician's name may be displayed prominently (e.g., near the top) of each of a plurality of clinician windows 120. The compliance data displayed in each clinician window may indicate the status of quality metrics for corresponding patients for which the respective clinician identified is responsible. In some cases, only patients with actionable and/or urgent quality metrics may be displayed. Furthermore, in some examples, as shown in FIG. 4, only the specific quality metrics that are actionable or urgent may be displayed and the displayed quality metrics may be ordered based on criticality or urgency. Although the display of FIG. 4 could be provided on a per condition basis, so that only quality metrics associated with one condition are shown, some examples may provide for cross-bundle display of quality metrics. Thus, for example, as shown in FIG. 4, the bundle or condition with which a particular quality metric is associated may be indicated (e.g., via the VAP, CHF or CVA initials associated with various quality bundles).

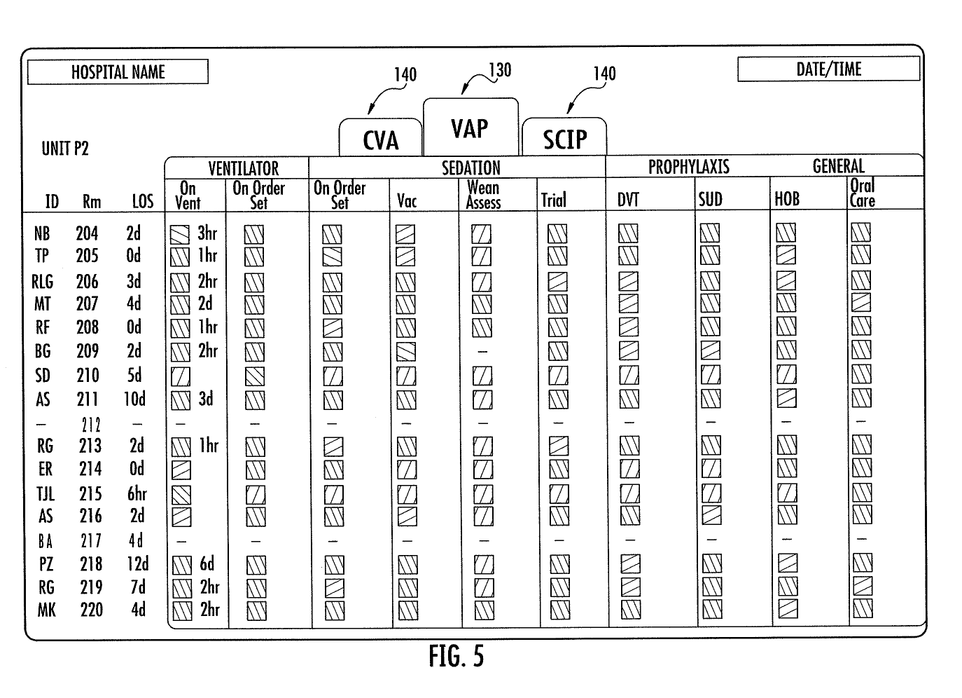

In some cases, more detailed information about a particular patient may be received by clicking on the patient identifier. For example, by clicking on the patient identifier, the more detailed information of FIG. 3 may be retrieved with or without other additional information. As such, in some cases, patient specific views may be provided. In some cases, selecting on the patient identifier may cause a switch between the display of FIG. 4 to the display of FIG. 3. However, in some examples a drop down menu or selectable icons may be provided to enable switching between different views. As yet another example, information for different conditions may be provided via respective selectable different pages as shown in the example of FIG. 5. In this regard, FIG. 5 shows an active page 130 and other selectable inactive pages 140. In response to selection of one of the inactive pages 140, the corresponding selected page would become an active page and the active page 130 would shift to being an inactive page. Corresponding updated status information for each quality metric associated with the active page may then be displayed and further updates may be provided periodically (e.g., every 5 or 15 minutes).

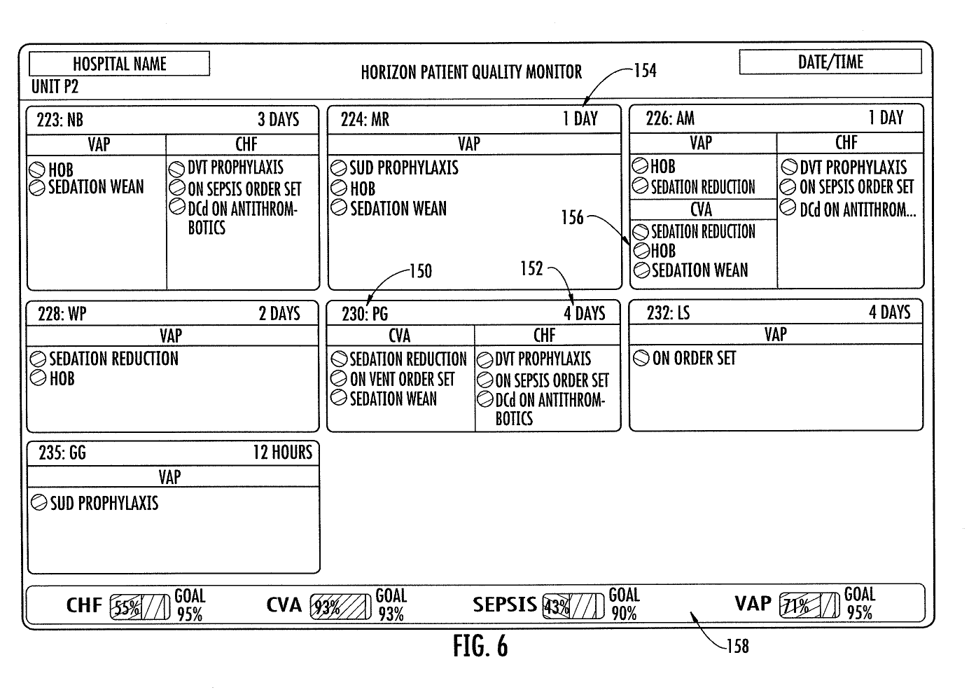

FIG. 6 illustrates an example display of an alternative view of the patient quality data that may be provided according to an exemplary embodiment. In this regard, FIG. 6 provides a per-patient view of filtered patient quality data that is comprehensive in relation to the different conditions for which the patient is being monitored. As such, for example, a report may be provided for compliance data relative to each of a plurality of patient identifiers 150 (each identifying a patient by initials and room number). An indication 152 of the time period for which the patient has been hospitalized may also be provided. The compliance data displayed in each patient window may indicate the status of quality metrics for corresponding conditions for which the respective patient identified is being monitored. In some cases, only quality metrics that are actionable and/or urgent may be displayed by employing a filtering process. In situations where multiple conditions are being monitored, a patient window 154 may be split to include sub-windows 156 for each respective condition being monitored. Headings may be provided for each sub-window 156 and the headings may be color coded to correlate the same condition between different patients and highlight the different conditions for which each patient is being monitored. As an alternative, all conditions for which monitoring is being conducted for a given patient may be mixed within one patient window. Ordering of data may be provided according to urgency and, particularly if sub-windows are not employed, a respective indicator may be provided to show the condition to which each respective quality metric corresponds.

In some embodiments, one or more of the displays provided may offer a condition based-compliance status bar 158. The condition based-compliance status bar 158 may be used to indicate overall compliance for patients being monitored for various different conditions on a condition by condition basis. Thus, for example, the condition based-compliance status bar 158 may provide an indication of compliance with respect to all patients being monitored for CHF (e.g., 55% in FIG. 6) relative to an organizational goal for that particular condition (e.g., 95% in FIG. 6). Color coding (e.g., green=goal met, yellow=close to meeting goal, red=unsatisfactory performance with respect to organizational goal) of a status bar providing the indication may be used to provide an at-a-glance representation of compliance for each condition thereby providing information as to which conditions may require increased attention with respect to compliance monitoring. In some cases the condition based-compliance status bar 158 may be set up by user preferences to show unit or organization-wide compliance status. However, users may be enabled to filter data to provide a condition based-compliance status bar on a per-clinician basis or other bases as well.

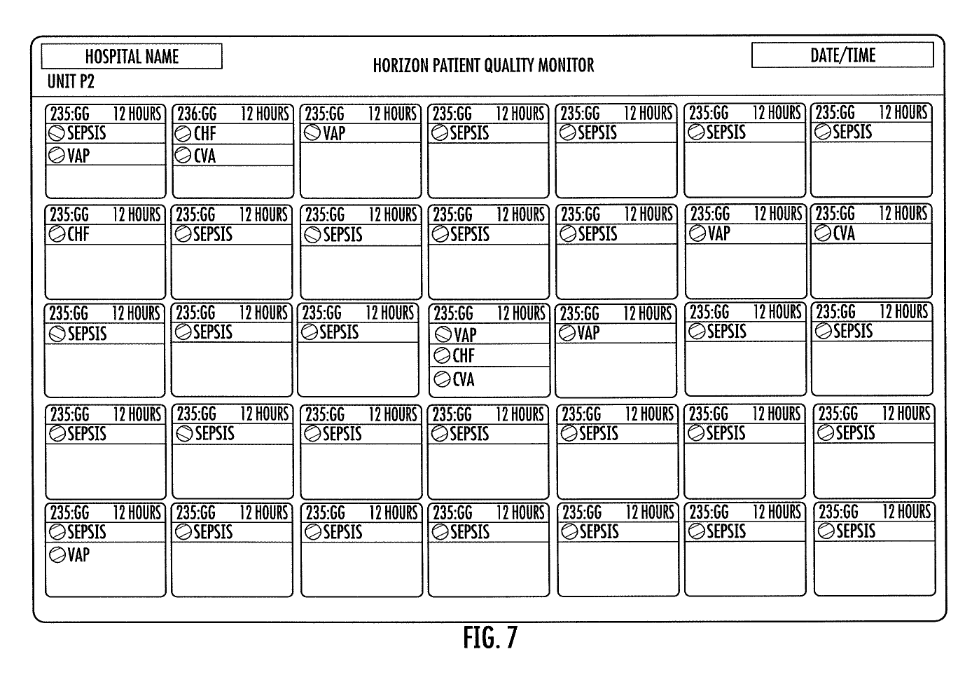

In some cases, each patient window 154 may be a fixed size in order to provide a predetermined number of patient windows on a given screen. In this regard, FIG. 7 illustrates an example of a relatively busy hospital floor with a plurality of substantially equal sized patient windows provided in order to fill the display with as much information as possible. In some cases, a threshold maximum number of windows may be included on each page, and if the threshold is exceeded, a new page may be included. However, in other cases, such as the example shown in FIG. 6, patient windows may be sized based on the amount of data being provided in each respective window or in windows sharing the same row. Thus, for example, one row may provide patient windows sized according to the size needed to accommodate the patient with the most data, while another row may provide patient windows having a smaller size if the data of all patients in that row is relatively less.

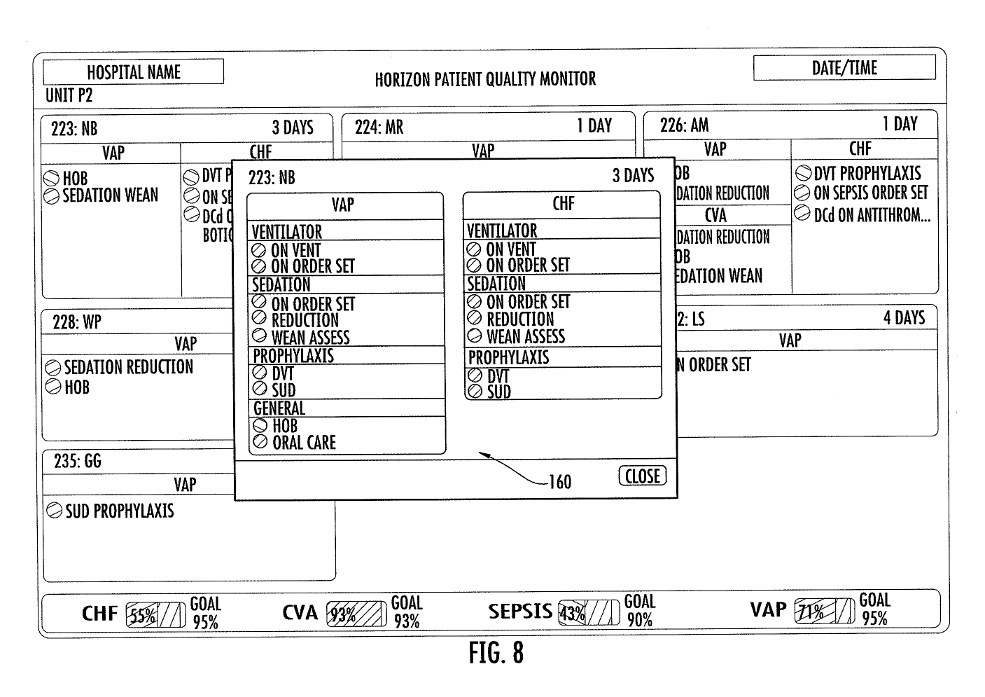

When a particular patient is selected (e.g., by clicking on the patient identifier 150, by selecting an icon (e.g., in a particular patient window) associated with providing a more detailed view, or by hovering over a particular patient window with a mouse or cursor), a detailed patient window 160 may be provided as shown in FIG. 8. In an exemplary embodiment, the detailed patient window 160 may include information previously filtered out, such as compliance data for activities for which monitoring indicates a compliant status. The detailed patient window 160 may provide data for multiple conditions or only a single condition, with links to data regarding other conditions. In some examples, the detailed patient window 160 may be provided to cover substantially all of the display area. However, in alternative examples, such as the one shown in FIG. 8, the detailed patient view 160 may be shown as an active window with the view shown in FIG. 6 suppressed in the background.

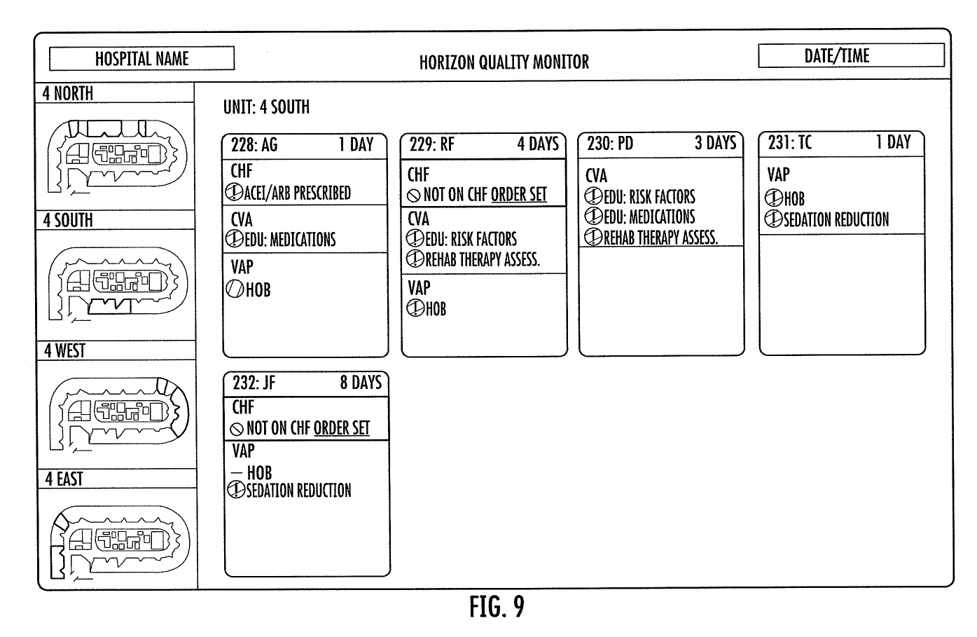

FIG. 9 shows another example of a display of a patient quality monitor according to an exemplary embodiment of the present invention. In this regard, FIG. 9 illustrates how monitoring of various patients for different conditions may be facilitated according to one example embodiment. In the example of FIG. 9, a particular floor (or unit) may be broken up into different regions. In this case, the regions are direction related and rooms in either the North, South, East or West regions or portions of the floor are segregated together. One portion of the display shown in FIG. 9 includes a floor overview showing a graphical depiction of the populated rooms in a corresponding directional region of the floor. For example, populated rooms in each respective region are highlighted in a distinctive manner (e.g., shading in this case). Furthermore, a selected one of the regions (e.g., the 4 South region) may then have detailed information presented in a detailed information window. The detailed information window may have a room number for each respective populated room and an indication of the length of time of an acute care admission for the corresponding patient displayed in a header or banner region associated with a console display for each room. Various conditions for which monitoring is being conducted may then be listed with indicators (e.g., icons) and text entries to identify the status of monitoring for each respective condition. In some cases, the icons or other portions of the individual console display for each room may be selectable to access more detailed information about the corresponding status.

Some embodiments of the present invention may therefore enable clinicians to relatively easily obtain an at a glance view of tasks that should be performed in order to ensure compliance with external and local standards for preventive care with respect to certain conditions, illnesses or treatments. This may provide a tool for resource management as well as for ensuring improved quality in relation to care provided to patients.

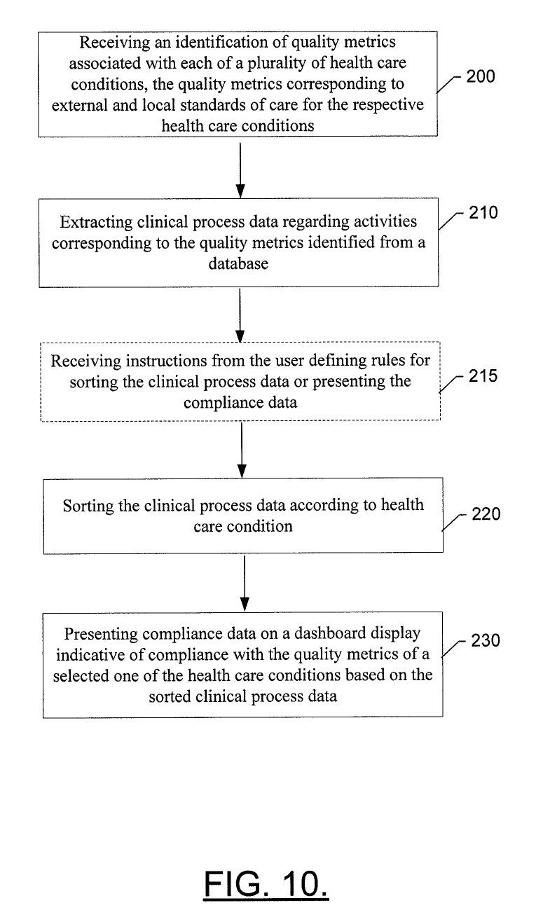

Embodiments of the present invention may therefore be practiced using an apparatus such as the one depicted in FIG. 2. However, other embodiments may be practiced in connection with a computer program product for performing embodiments of the present invention. FIG. 10 is a flowchart of a method and program product according to exemplary embodiments of the invention. Each block or step of the flowchart of FIG. 10, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

In this regard, a method according to one embodiment of the invention, as shown in FIG. 10, may include receiving an identification of quality metrics associated with each of a plurality of health care conditions in which the quality metrics corresponding to external standards of care for the respective health care conditions at operation 200 and extracting clinical patient quality data regarding activities corresponding to the quality metrics identified from a database at operation 210. The method may further include sorting the clinical patient quality data according to health care condition at operation 220 and presenting compliance data on a dashboard display indicative of compliance with the quality metrics of a selected one of the health care conditions based on the sorted clinical patient quality data at operation 230.

In some cases, the method may include additional optional operations, an example of which is shown in dashed lines in FIG. 10. In this regard, in an exemplary embodiment, the method may further include receiving instructions from a user defining rules for sorting the clinical process data or presenting the compliance data at operation 215. In some embodiments, modifications may be made to the operations described above. For example, in some cases, presenting compliance data may include presenting only compliance data that has a completion time requirement that is not met and within a predetermined value or presenting compliance data for patients associated with a particular clinician in a separate window associated with the particular clinician. In other examples, presenting compliance data may include presenting compliance data for patients in a particular unit of a healthcare facility or presenting each quality metric with a corresponding status indication indicative of a completion status of an activity associated with the quality metric. In some cases, presenting compliance data may include presenting at least one group of quality metrics with a single status indication indicative of a completion status of activities associated with the group of quality metrics. In some embodiments, receiving the indication of quality metrics may include receiving at least one set of quality metrics that includes both external standards and local standards established by a healthcare facility employing the dashboard display. Other modifications are also possible. The modifications and optional operations may be included in any combination and in any order with respect to the operations 200-230 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a patient quality monitor comprising:
receiving an identification of quality metrics associated with each of a plurality of health care conditions, the quality metrics corresponding to external standards of care for the respective health care conditions;
extracting clinical patient quality data regarding activities corresponding to the quality metrics identified from a database;
sorting the clinical patient quality data according to health care condition; and
presenting compliance data on a dashboard display indicative of compliance with the quality metrics of a selected one of the health care conditions based on the sorted clinical patient quality data.

2. The method of claim 1, wherein presenting compliance data comprises presenting only compliance data that has a completion time requirement that is not met and within a predetermined value.

3. The method of claim 1, wherein presenting compliance data comprises presenting compliance data for patients associated with a particular clinician in a separate window associated with the particular clinician.

4. The method of claim 1, wherein presenting compliance data comprises presenting compliance data for patients in a particular unit of a healthcare facility.

5. The method of claim 1, wherein presenting compliance data comprises presenting each quality metric with a corresponding status indication indicative of a completion status of an activity associated with the quality metric.

6. The method of claim 5, wherein presenting compliance data comprises presenting at least one group of quality metrics with a single status indication indicative of a completion status of activities associated with the group of quality metrics.

7. The method of claim 1, wherein receiving the indication of quality metrics comprises receiving at least one set of quality metrics that includes both external standards and local standards established by a healthcare facility employing the dashboard display.

8. The method of claim 1, further comprising receiving instructions from the user defining rules for sorting the clinical patient quality data or presenting the compliance data.

9. The method of claim 1, wherein presenting compliance data comprises providing a display of a plurality of patient windows in which each patient window includes compliance data for a respective patient.

10. The method of claim 9, wherein each patient window provides filtered compliance data based on a state of the compliance data displayed.

11. The method of claim 10, wherein selection of one patient window provides an unfiltered view of compliance data for a corresponding patient.

12. A computer program product for providing a patient quality monitor, the computer program product comprising at least one computer-readable storage medium having computer-executable program code instructions stored therein, the computer-executable program code instructions comprising:
program code instructions for receiving an identification of quality metrics associated with each of a plurality of health care conditions, the quality metrics corresponding to external standards of care for the respective health care conditions;
program code instructions for extracting clinical patient quality data regarding activities corresponding to the quality metrics identified from a database;
program code instructions for sorting the clinical patient quality data according to health care condition; and
program code instructions for presenting compliance data on a dashboard display indicative of compliance with the quality metrics of a selected one of the health care conditions based on the sorted clinical patient quality data.

13. The computer program product of claim 12, wherein program code instructions for presenting compliance data include instructions for presenting only compliance data that has a completion time requirement that is not met and within a predetermined value.

14. The computer program product of claim 12, wherein program code instructions for presenting compliance data include instructions for presenting compliance data for patients associated with a particular clinician in a separate window associated with the particular clinician.

15. The computer program product of claim 12, wherein program code instructions for presenting compliance data include instructions for presenting compliance data for patients in a particular unit of a healthcare facility.

16. The computer program product of claim 12, wherein program code instructions for presenting compliance data include instructions for presenting each quality metric with a corresponding status indication indicative of a completion status of an activity associated with the quality metric.

17. The computer program product of claim 12, wherein program code instructions for receiving the indication of quality metrics include instructions for receiving at least one set of quality metrics that includes both external standards and local standards established by a healthcare facility employing the dashboard display.

18. The computer program product of claim 12, further comprising program code instructions for receiving instructions from the user defining rules for sorting the clinical process data or presenting the compliance data.

19. An apparatus comprising processing circuitry configured to:
receive an identification of quality metrics associated with each of a plurality of health care conditions, the quality metrics corresponding to external standards of care for the respective health care conditions;
extract clinical patient quality data regarding activities corresponding to the quality metrics identified from a database;
sort the clinical patient quality data according to health care condition; and
present compliance data on a dashboard display indicative of compliance with the quality metrics of a selected one of the health care conditions based on the sorted clinical patient quality data.

20. The apparatus of claim 19, wherein the processing circuitry is further configured to receive instructions from the user defining rules for sorting the clinical process data or presenting the compliance data.
